(19) United States
(12) Patent Application Publication
(10) Pub. No.: US 2024/0366466 A1
(43) Pub. Date: Nov. 7, 2024

(54) RECIPROCATING MASSAGE THERAPY APPARATUS

(71) Applicant: Health Devices Corporation, North Hollywood, CA (US)

(72) Inventor: Francois Hacquard, San Pedro, CA (US)

(21) Appl. No.: 18/310,781

(22) Filed: May 2, 2023

(51) Int. Cl. A61H 19/00; A61H 23/02

(52) U.S. Cl. CPC A61H 19/40; A61H 23/02; A61H 2201/0119; A61H 2201/0157; A61H 2201/5097

(57) ABSTRACT

A reciprocally-driven massage therapy apparatus includes a base unit operable to rest on or mount to a surface that is external to the apparatus. A reciprocal drive unit is mounted to the base unit, the reciprocal drive unit including a reciprocally-driven member. A massage therapy implement is disposed on the reciprocally-driven member and arranged to stroke back and forth to apply cyclic therapeutic touching to a user's body part during use of the apparatus. The base unit may include an adjustable ballast operable to apply a stabilizing force that enhances stability of the apparatus. The reciprocal drive unit may be wirelessly controllable and the massage therapy implement may have wirelessly controllable motorized components for delivering massage therapy functions. A multi-function wireless remote control device may be provided that selectively controls the reciprocal drive unit and the massage therapy implement's motorized components.

### BACKGROUND

### 1. Field

The present disclosure relates to massage therapy apparatus. More particularly, the disclosure concerns a massage therapy apparatus in which a massage therapy implement is reciprocally-driven to effect a linear stroking motion in which the implement slidably engages a user's body part to apply cyclic therapeutic touching.

### 2. Description of the Prior Art

By way of background, reciprocating massage therapy apparatus are known in which an inert stroking implement (such as a dildo) is mounted to the end of a reciprocating throw arm powered by a motor drive unit that is secured to a base frame. The base frame is designed to rest on a horizontal surface such as a hard floor, carpet, or bed mattress. If the horizontal surface is smooth, suction cups may be used to help stabilize the base frame so that the apparatus is anchored for use. However, if the horizontal surface is not compatible with suction cups, such as a carpet or a bed mattress, the apparatus will simply rest on the surface such that there is little stability during use. Even if the apparatus can be secured by suction cups to a smooth surface, the suction cups may detach due to the large forces generated by the apparatus, particularly at high stroke speeds, such that the apparatus once again becomes unstable.

Existing reciprocating massage therapy apparatus also tend to be monofunctional and mono-controllable. They simply stroke the stroking implement in a linear back and forth motion, and the user's only mode of control is to adjust the stroking speed.

Applicant submits that it would be desirable to provide a reciprocating massage therapy apparatus that overcomes the foregoing disadvantages.

### SUMMARY

A reciprocally-driven massage therapy apparatus includes a base unit operable to rest on or mount to a surface that is external to the apparatus. A reciprocal drive unit is mounted to the base unit. The reciprocal drive unit includes a reciprocally-driven member. A massage therapy implement is disposed on the reciprocally-driven member and arranged to stroke back and forth to apply cyclic therapeutic touching to a user's body part during use of the apparatus.

In one aspect, the base unit may include an adjustable ballast operable to apply a stabilizing force that enhances stability of the apparatus. The ballast may implemented using one or more ballast containers, each having a hollow interior configured to hold a ballast material, with a closable opening being provided for introducing the ballast material. The ballast container(s) may be detachably mounted to the base to facilitate the addition or removal of ballast material.

In another aspect, the reciprocal drive unit may be wirelessly controllable and the massage therapy implement may include wirelessly controllable motorized components for delivering active massage therapy functions. A multi-function wireless remote control device may be provided that selectively controls both the reciprocal drive unit and the massage therapy implement's motorized components.

In a further aspect, the massage therapy implement may be detachable from the reciprocally-driven member and replaceable with additional wirelessly controllable massage therapy implements that can be mounted to the reciprocally-driven member and controlled by the multi-function wireless remote control device.

In a further aspect, the massage therapy implement may be detachable from the reciprocally-driven member and attachable to a massage therapy implement handle in order to provide a stand-alone hand-held massage therapy implement.

In a further aspect, the reciprocal drive unit may include a mounting connection that detachably connects to a drive unit support frame of the base, and a reciprocal drive unit handle may be attached to the reciprocal drive unit in order to use the reciprocal drive unit as a stand-alone handheld massage therapy device.

In a further aspect, a reciprocating massage therapy kit may be provided that includes a reciprocating massage therapy apparatus having a base, a base-mounted reciprocal drive unit having a reciprocally-driven member, and one or more kit accessories. The kit accessories may include one or more massage therapy implements that can be detachably mounted on the reciprocally-driven member. The kit accessories may further include a wireless remote control device for selectively controlling the reciprocal drive unit and the one ore more massage therapy implements. The kit accessories may further include a massage therapy implement handle that is selectively attachable to the one or more massage therapy implements so that they can function as stand-alone, handheld massage therapy implements. The kit accessories may further include an articulating handle member that is attachable to the reciprocal drive unit when it is detached from the base in order to form a stand-alone, handheld reciprocating massage therapy device.

### BRIEF DESCRIPTION OF THE DRAWINGS

The foregoing and other features and advantages will be apparent from the following more particular description of example embodiments, as illustrated in the accompanying Drawings.

FIG. 1 is upper perspective view showing a reciprocating massage therapy apparatus constructed in accordance with an embodiment of the present disclosure.

FIG. 2 is a lower perspective view showing the FIG. 1 massage therapy apparatus.

FIG. 3 is a segmented upper perspective view of a base unit of the FIG. 1 massage therapy apparatus, with a central section of the of the base unit broken away in order to illustrate a feature thereof.

FIG. 4 is a left side elevation view of a reciprocal drive unit of the FIG. 1 massage therapy apparatus.

FIG. 5 is a right side elevation view of the reciprocal drive unit of the FIG. 4.

FIG. 6 is a top plan view of the reciprocal drive unit of the FIG. 4.

FIG. 7 is a bottom view of the reciprocal drive unit of the FIG. 4.

FIG. 8 is a front view of the reciprocal drive unit of the FIG. 4.

FIG. 9 is a rear view of the reciprocal drive unit of the FIG. 4.

FIG. 10 is a side view of a massage therapy implement of the FIG. 1 massage therapy apparatus.

FIG. 11 is a rear view of the massage therapy implement of FIG. 10.

FIG. 12 is a cross-sectional centerline view of the massage therapy implement of FIG. 10 taken along line 12-12 in FIG. 11.

FIG. 13 is an upper perspective view of the FIG. 1 massage therapy apparatus in combination with a remote control device that controls the reciprocal drive unit of FIG. 4 and the massage therapy implement of FIG. 10.

FIG. 14 is a side elevation view of the massage therapy implement of FIG. 10 arranged for removable mounting to the reciprocal drive unit of FIG. 4.

FIG. 15 is a side elevation view of the massage therapy implement of FIG. 10 arranged for removable mounting to a massage therapy implement handle in order to form a stand-alone hand-held massage therapy implement.

FIG. 16 is a side elevation view of an alternative massage therapy implement arranged for removable mounting to the reciprocal drive unit of FIG. 4.

FIG. 17 is a side elevation view of the alternative massage therapy implement of FIG. 16 arranged for removable mounting to a massage therapy implement handle in order to form an alternative stand-alone hand-held massage therapy implement.

FIG. 18 is a side elevation view of the reciprocal drive unit of FIG. 4 mounted to a drive unit support frame of the base unit of FIG. 1.

FIG. 19 is a side elevation view of the reciprocal drive unit of FIG. 4 arranged

for removable mounting to the drive unit support frame of FIG. 18.

FIG. 20 is a rear view of the reciprocal drive unit of FIG. 4 mounted to the drive unit support frame of FIG. 18.

FIG. 21 is a rear view of the reciprocal drive unit of FIG. 4 arranged for removable mounting to the drive unit support frame of FIG. 18.

FIG. 22 is an exploded rear left perspective view of the reciprocal drive unit of FIG. 4 illustrating a rotatable mounting assembly thereof.

FIG. 23 is an exploded rear right perspective view of the reciprocal drive unit of FIG. 4 illustrating the rotatable mounting assembly of FIG. 22.

FIG. 24 is a side elevation view of the reciprocal drive unit of FIG. 4 illustrating a rotatable adjustment function of the rotatable mounting assembly of FIG. 22.

FIG. 25 is an exploded rear left perspective view of the reciprocal drive unit of FIG. 4 illustrating a rotatable handle assembly arranged for removable mounting thereto to form a stand-alone handheld massage therapy device.

FIG. 26 is an exploded rear right perspective view of the reciprocal drive unit of FIG. 4 illustrating the rotatable handle assembly of FIG. 25.

FIG. 27 is a side elevation view of the reciprocal drive unit of FIG. 4 with the rotatable handle assembly of FIG. 25 mounted thereto and illustrating a rotatable adjustment function of the rotatable handle assembly.

FIG. 28 is an upper perspective view of a massage therapy kit that includes the massage therapy apparatus of FIG. 1, the massage therapy implement of FIG. 1, the remote control device of FIG. 13, the massage therapy implement handle of FIG. 15, the alternative massage therapy implement of FIG. 16, and the rotatable handle assembly of FIG. 25.

### DETAILED DESCRIPTION OF EXAMPLE EMBODIMENTS

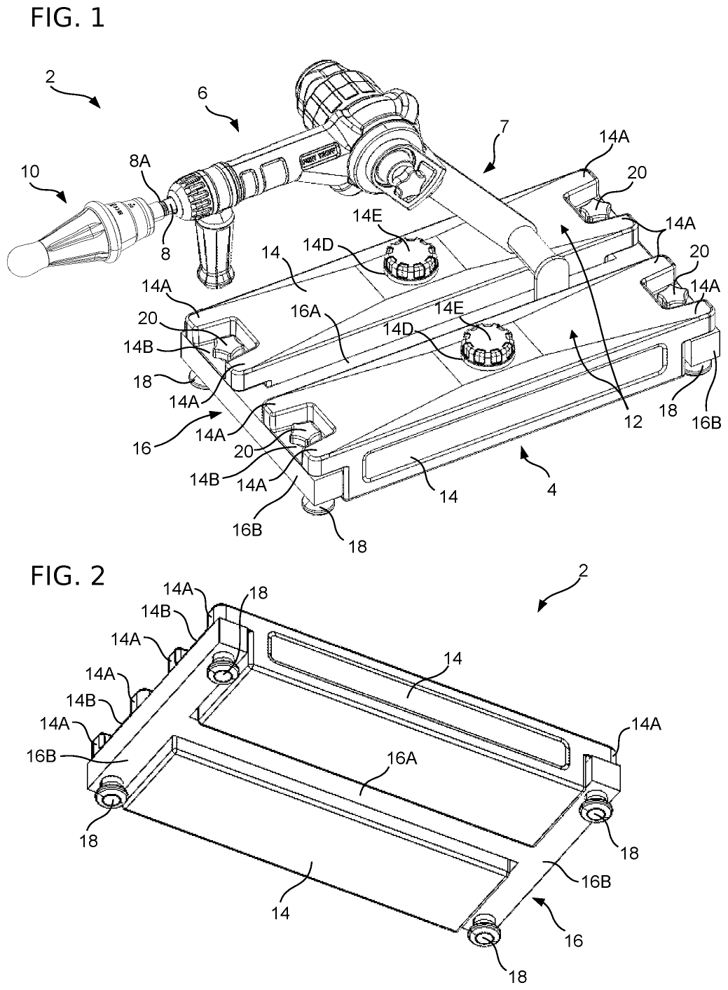

Turning now to the figures, wherein like reference numerals represent like elements in all of the several views, FIG. 1 depicts a reciprocating massage therapy apparatus 2 that may be constructed in accordance with an example embodiment. In this illustrated embodiment, the massage therapy apparatus 2 includes a base unit 4 that is configured and operable to rest on (or mount to) a surface that is external to the apparatus, such as a floor, bed or other surface, be it horizontal or non-horizontal (e.g., sloping). A reciprocal drive unit 6 is suitably mounted to the base unit 4, such as by way of a drive unit support frame 7. The reciprocal drive unit 6 includes a reciprocally-driven throw arm member 8 powered by an electric motor (not shown) disposed within the drive unit. A massage therapy implement 10 is disposed on the reciprocally-driven member 8 and arranged to stroke back and forth to apply cyclic therapeutic touching to a user's body part (not shown) during use of the massage therapy apparatus 2.

The massage therapy implement 10 may be take many forms, including as an inert (non-active) device such as a solid rubber dildo, or a motorized (active) device such as a vibrator having internal motor-driven components. In embodiments wherein the massage therapy implement 10 is a non-active device, it will deliver reciprocating massage therapy as a result of being mounted to (and stroked by) the reciprocally-driven member, but no additional massage therapies. In embodiments wherein the massage therapy implement 10 is an active device, it will deliver one or more massage therapies that are native to the implement, and which are independent of and supplemental to the reciprocating massage therapy delivered as a result of the implement being mounted to (and stroked by) the reciprocally-driven member 8.

In an embodiment, the base unit may be provided with an adjustable ballast 12 whose mass applies a downward stabilizing force that enhances stability of the massage therapy apparatus 2. The adjustable ballast 12 may be provided in various ways. In the illustrated embodiment, the ballast 12 is implemented using one or more ballast containers 14 (two are shown) configured to hold a ballast material. The ballast containers 14 are attached to a rigid base frame 16.

As additionally shown in FIG. 2, the base unit 4 may include gripping foot members 18 positioned on the bottom of the base frame for gripping the external surface on which the massage therapy apparatus 2 is supported. Given that the use of suction cups as found in conventional reciprocally-driven massage therapy apparatus has not been entirely satisfactory, the gripping foot members 18 may be implemented as non-suction anchor feet members whose lower surfaces are not so flexible as to be capable of developing a suction force, but soft enough to grip and hold to the external surface. For most surfaces, including hard floors, carpeted floors, beds, etc., the gripping foot members 18 can be made from a medium hardness elastomeric rubber-like material (e.g., soft PVC (polyvinyl chloride)) that is formed with a friction-enhancing surface texture. Notwithstanding the fact that the illustrated embodiment eschews suction members, it should be understood that the gripping members 18 could be formed as suction members to provide an alternate embodiment, if so desired.

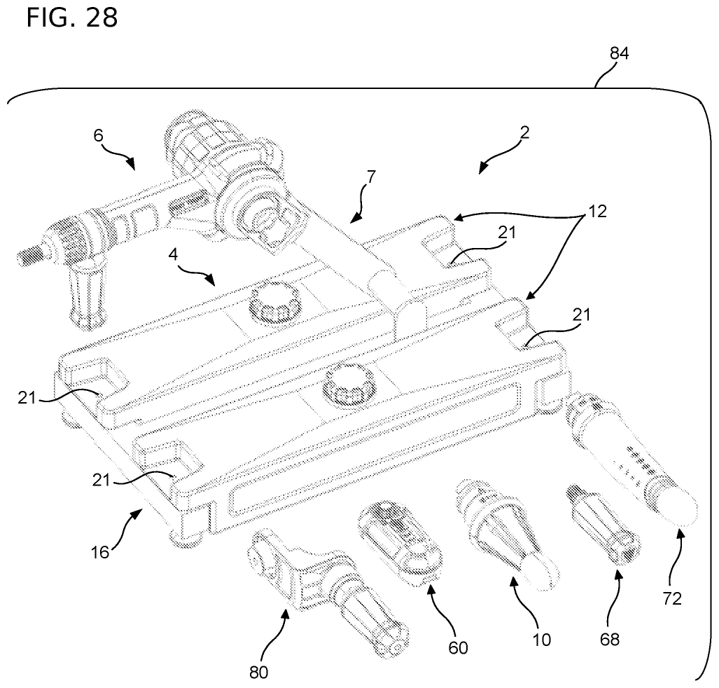

The ballast 14 may removably attached to the base frame 16 in a manner that allows the ballast to be attached to the base frame and detached therefrom by hand without the use of a tool device such as a screwdriver, wrench, pliers, etc. In the illustrated embodiment, this is accomplished using a pair of thumb screws 20 to secure each ballast container 14 to the base frame 16. The thumb screws 20 extend through apertures 21 (shown in FIG. 28) formed at the ends of the ballast containers 14, and thread into tapped holes (not shown) formed in the base frame 16.

As can be seen in FIG. 2, the base frame 16 may be optionally formed as an H-shaped structure having a central longitudinal frame section 16A and two transverse frame sections 16B, one on each end of the longitudinal frame section. Many other shapes may also be used. Square tubing or other rigid material may be used to form the frame sections 16A and 16B. The ballast containers 14 are secured by the thumb screws 20 to the transverse frame sections 16B of the base frame 16. To effectuate this mounting arrangement, the end of each ballast container 14 may be formed with a pair of support arms 14A that rest on one of the transverse frame sections 16B. The thumb screws 20 are situated between the support arms 14A. As previously noted, they extend through apertures 21 (shown in FIG. 28), which may be formed in a thin web flange 14B (see FIG. 1) that extends between the support arms.

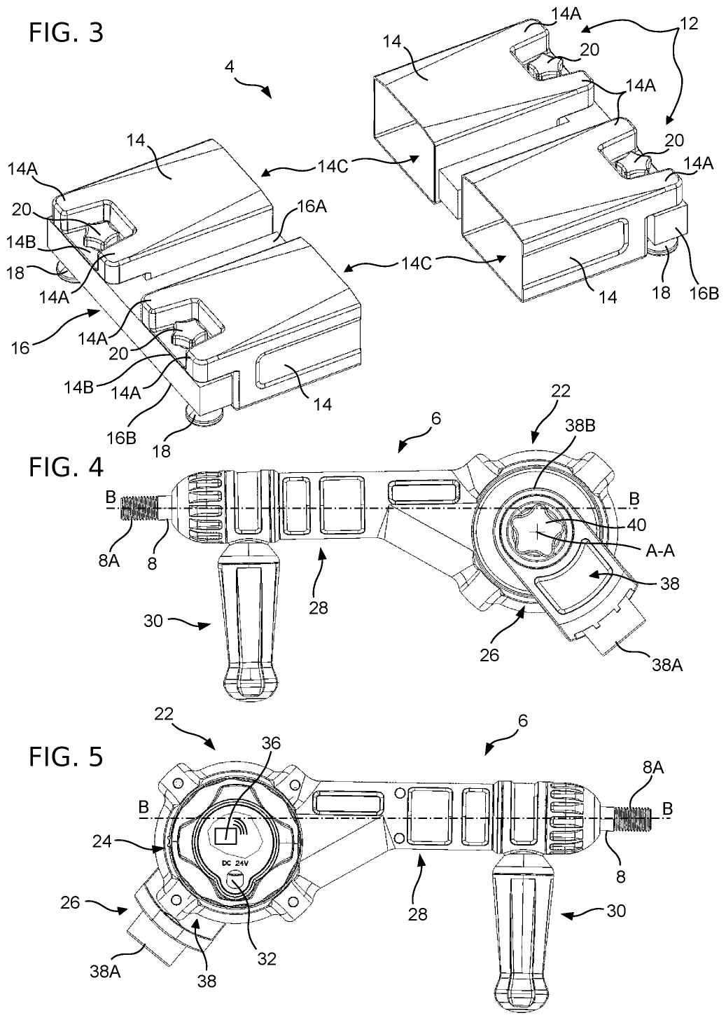

As shown in FIG. 3, each ballast container 14 may be formed as a ballast tank having a hollow interior 14C configured to hold a ballast material (not shown). The hollow interior 14C may extend the entire length of each ballast container 14, including into the support arms 14A. In order to increase the amount of ballast material that can be held by each ballast container 14, the ballast container depth may be increased in the region thereof that lies between the transverse frame sections 16B. In the illustrated embodiment, the depth of the ballast container 14 is increased by lowering the bottom thereof into proximity with the gripping foot members 18.

As shown in FIG. 1, an opening 14D may be provided on the top of each ballast container 14 for introducing ballast material into the hollow interior 14C. A removable sealable closure 14E, such as a water-tight screw cap, may be provided to close and seal the opening 14C. The ballast material may be any flowable substance that can be introduced into the ballast containers 14 through the openings 14D, and which is sufficiently dense to provide sufficient mass to prevent unwanted movement of the base unit 4 during operation of the massage therapy apparatus 2. Example ballast materials include liquids such as water, solid particulates such as sand, and slurries such as water/sand mixtures. Advantageously, the ballast containers 14 can be easily detached from the base fame 16 (by removing the thumb screws 20) when it is desired to add or remove ballast material to or from the ballast containers. By using a flowable ballast material, the mass of the ballast 12 can be controlled according to operational requirements and/or user preferences, including competing factors such as base unit stability vs. base unit portability. Notwithstanding the advantages of a flowable ballast material, it will be appreciated that a fixed mass ballast 12 may be used. In that case, the ballast containers 14 could be sealed containers filled with a selected amount of ballast material. In other embodiments, solid ballast, such as weights that are configured to removably mount to the base frame 16, could be used in lieu of the ballast containers 14 containing ballast material.

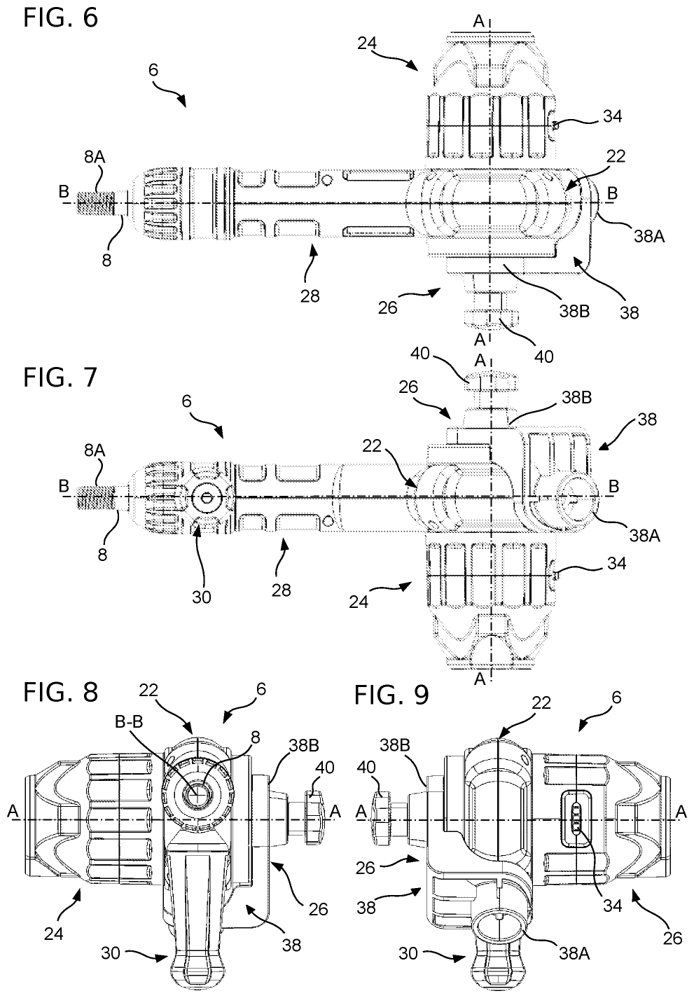

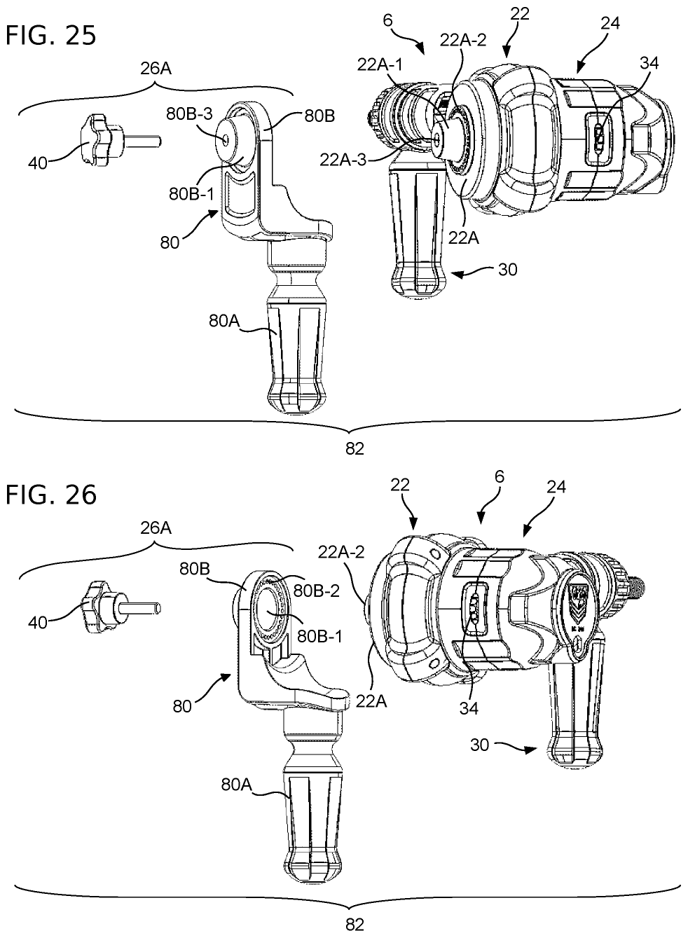

Turning now to FIGS. 4-9, the reciprocal drive unit 6 may be configured with a generally circular main hub 22, the center of which lies on a central main hub axis A-A (FIGS. 4 and 6-9). Also centered on the hub axis A-A are two additional components of the reciprocal drive unit 6, namely, a motor compartment 24 (FIGS. 6-9) that extends transversely from one side of the main hub 22, and a rotatable mounting assembly 26 (FIGS. 6-9) that extends transversely from the opposite side of the main hub. The reciprocal drive unit 6 may further include an elongated barrel 28 formed as a generally cylindrical structure that extends radially frontward from the main hub 22, the center of which lies on a central longitudinal barrel axis B-B (FIGS. 4-8). A front handle 30 may be provided that extends downwardly from the barrel 28, near the front terminal end of the barrel 28 (where the reciprocally-driven member 8 emerges). As discussed in connection with FIGS. 25-27 below, the front handle 30 may be used (in combination with a rear handle) when the reciprocal drive unit 6 is detached from the drive unit support frame 7 in order to operate as a stand-alone, handheld reciprocating massage therapy device.

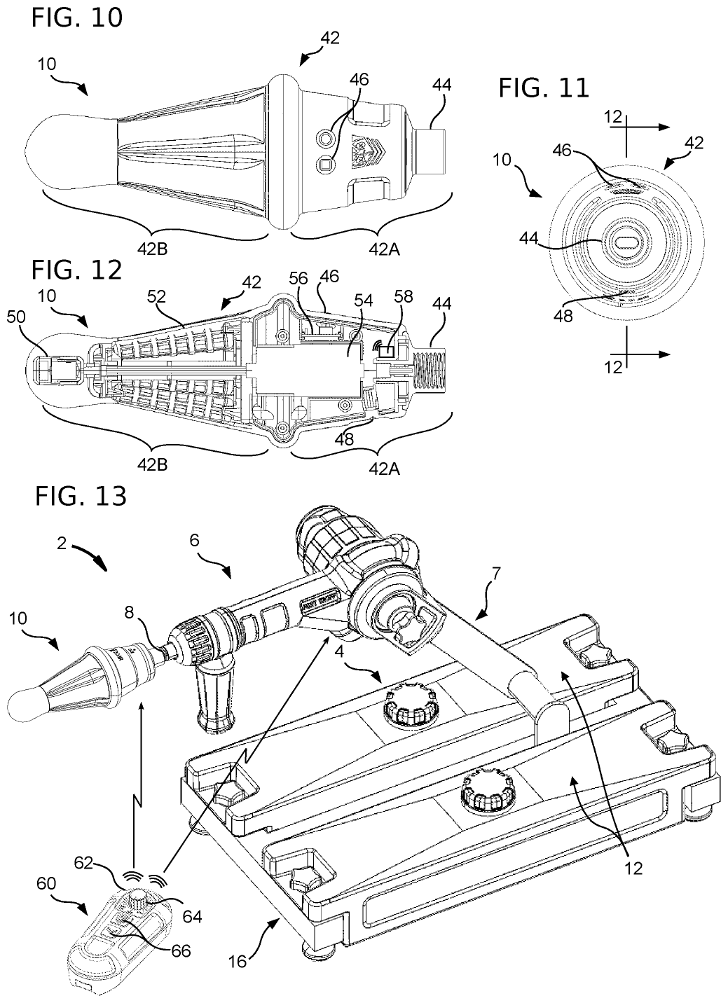

Although not shown, the reciprocal drive unit 6 further includes an electric drive motor disposed within the motor compartment 24 and a crank disposed within the main hub 22. The output shaft of the drive motor is operatively connected to the crank (e.g., directly or indirectly by way of a gear system) so that the crank rotates about the hub axis A-A. The crank may be operatively connected to a rearward driven-end the reciprocally-driven drive member 8 (e.g., by way of a connecting rod or a slotted link mechanism (a.k.a. scotch yoke)) so that the drive member is reciprocated along the barrel axis B-B to effect the back and forth stroking of the massage therapy implement 10. As can be seen in FIGS. 1 and 4-7, a non-driven forward end 8A of the reciprocally-driven member 8 extends from the barrel 28. As described in more detail below in connection with FIGS. 10-12, the reciprocally-driven member's forward end 8A may be configured in any suitable manner to facilitate removable attachment to the massage therapy implement 10.

Additional components of the reciprocal drive unit 6 include a DC power port 32 (FIG. 5) and a thumbwheel control device (FIG. 9), both of which are situated on the motor compartment 24. As shown in FIG. 5, the DC power port may be provided on the exposed end of the motor compartment 24 (or elsewhere) in order to receive a power cord plug that delivers electrical power (e.g., from a 20 volt direct current power source) for energizing the drive motor disposed within the motor compartment. As shown in FIG. 9, the thumbwheel control device 34 may be provided on a rear side of the motor compartment 24 (or elsewhere) in order activate/deactivate the drive motor and selectively vary its speed. This allows a user to manually control the reciprocation rate of the reciprocally-driven member 8, and thus vary the back and forth stroke of the massage therapy implement 10.

In order to facilitate remote user control of the reciprocal drive unit, a wireless remote control interface 36 (FIG. 5) may be provided within the interior of the motor compartment 24. The wireless interface 36 includes a wireless communication device designed for short-range operation (such as a radio receiver, an infrared receiver, etc.). As described in more detail below in connection with FIG. 13, the remote control interface 36 is operable to control the reciprocal drive unit 6 in order to vary the back and forth stroke of the massage therapy implement 10 based on control inputs sent from a wireless remote control device.

As can be seen in FIGS. 4 and 6-9, the rotatable mounting assembly 26 of the reciprocal drive unit 6 may be implemented as a two-component arrangement that includes an articulating mounting bracket 38 rotatably mounted to the main hub 22, and a thumb screw 40. As will be described in more detail below in connection with FIGS. 18-21, a swinging free end of the articulating mounting bracket 38 may be formed with a tubular mounting socket 38A (see FIGS. 4, 5 and 9) that non-detachably (or detachably) connects to the drive unit support frame 7. As described in more detail below in connection with FIGS. 22-24, a rotating base end of the articulating mounting bracket 38 may be formed with a rotary hub 38B that rotatably connects to the main hub 22 (see FIGS. 4 and 6-9). Although not shown in FIGS. 4-9, the rotary hub 38B is formed with a central aperture that is coaxially aligned with the main hub axis 22. The thumb screw 40 extends through that central aperture and threads into the main hub 22. The thumb screw 40 can be tightened to fix the articulating mounting bracket 38 at a desired rotational position, or loosened to facilitate rotational adjustment thereof.

Turning now to FIGS. 10-12, the massage therapy implement 10 is depicted according to an example embodiment as having a plug-type dildo configuration, with many other configurations also being possible. The massage therapy implement 10 includes a housing 42 having a base section 42A and a therapy delivery section 42B. The massage therapy implement 10 may be configured in any suitable manner for attachment to the forward end 8A of the reciprocally-driven member 8. By way of example only, FIGS. 10-12 illustrate one possible configuration wherein a female-threaded socket 44 is provided at the rearward end of the base section 42A for removably attaching the massage therapy implement 10 to male-threads that may be formed on the forward end 8A of the reciprocally-driven member 8. Many other attachment arrangements may also be used. As best shown in FIGS. 10 and 12, the base section 42A carries manual control buttons 46 and a charge port 48. The control buttons 46, which may include an on-off button and a mode select button, control one or more motorized components disposed within the therapy delivery section 42B of the massage therapy implement housing 42 that are operable to deliver one or more associated massage therapy functions. As shown in FIG. 12, the illustrated embodiment of the massage therapy implement 10 includes a motorized vibration component 50 and a motorized rotating beads component 52 disposed within the therapy delivery section 42B. The base section 42A of the massage therapy implement housing 42 contains a battery power source 54, and an electronic control board 56 powered by the battery 54 and operatively connected to the motorized components 50 and 52. The control board 56 is also operatively connected to the charge port 48 in order to mediate charging of the battery 54.

The massage therapy implement 10 may thus operate as a motorized dildo that is stroked by the the reciprocal drive unit 6 when attached thereto as part of the massage therapy apparatus 2 to deliver a stroking type of massage therapy. At the same time, the massage therapy implement 10 can be selectively activated to deliver its native massage therapy functions, such as may be provided by the motorized vibration component 50 and the motorized rotating beads component 52. As noted, these native massage therapy functions can be controlled using the control buttons 46.

In addition, the massage therapy implement 10 may be equipped with a wireless remote control interface 58 (FIG. 12) that is disposed within the interior of the base section 42A of the massage therapy implement housing 42. The remote control interface 58 includes a wireless communication device designed for short-range operation (such as a radio receiver, an infrared receiver, etc.). As described in more detail below in connection with FIG. 13, the remote control interface 58 is operable to selectively control the motorized vibration component 50 and the motorized rotating beads component 52 based on control inputs sent from a wireless remote control device in order to mediate delivery of the massage therapy functions.

Turning now to FIG. 13, a centralized wireless remote control device 60 as earlier mentioned is shown. As described in more detail below in connection with FIG. 28, the wireless remote control device 60 may be provided with the massage therapy apparatus 2 as part of a massage therapy apparatus kit. Advantageously, the wireless remote control device 60 may be implemented as a multi-function device that is operable to wirelessly communicate with both the reciprocal drive unit wireless remote control interface 36 (FIG. 5) and the massage therapy implement wireless remote control interface (FIG. 12). Disposed within the wireless remote control device 60 is a wireless communication device 62 designed for short-range operation (such as a radio transmitter, an infrared transmitter, etc.). A battery power source (not shown) may be provided to power the wireless communication device 62.

Adjustable control components are provided on the wireless remote control device 60 in order to selectively control (1) the reciprocally-driven member 8 of the reciprocal drive unit 6 to vary the back and forth stroke of the massage therapy implement 10, and (2) the motorized components 50 and 52 of the massage therapy implement 10 to vary delivery of the corresponding massage therapy functions of the massage therapy implement. In the illustrated embodiment of FIG. 13, a control knob 64 is provided for activating and deactivating the reciprocally-driven member 8 and for varying its stroking speed. A pair of control buttons 66 are provided for independently controlling the motorized vibration component 50 and the motorized rotating beads component 52 of the massage therapy implement 50, with the user controlling whether these components operate simultaneously or at different times, as well as the intensity of the massage therapy delivered thereby. The wireless remote control device 60 thus provides a user with the ability to remotely control both the reciprocal drive unit 6 and the native massage functions of the massage therapy implement 10, without having to access any manual controls on either device.

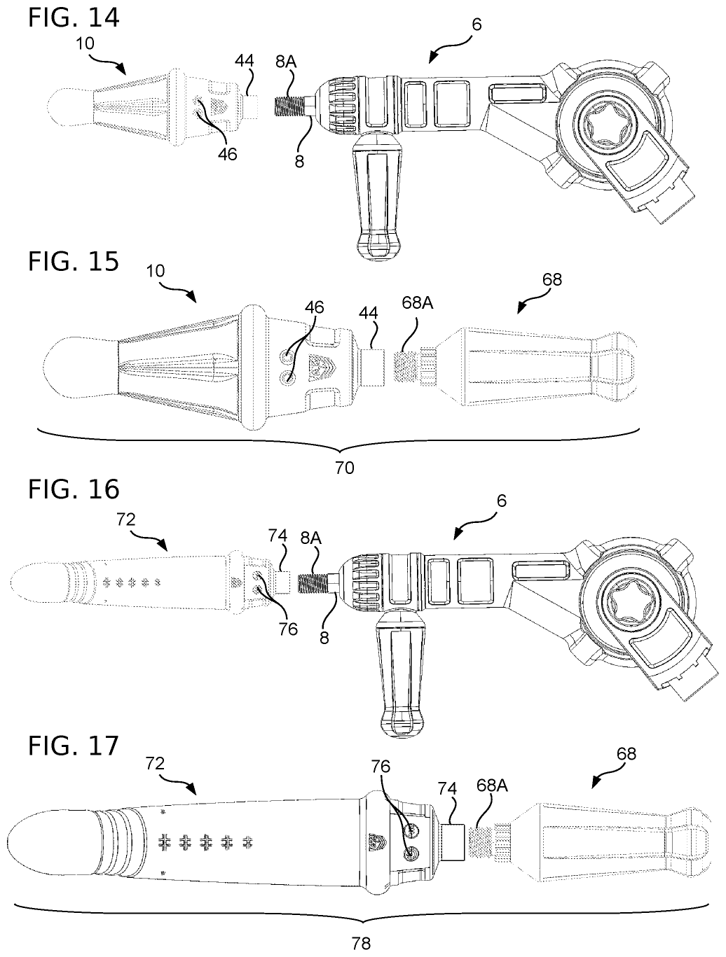

Turning now to FIGS. 14-15, the massage therapy implement 10 may be detached from the reciprocally-driven member 8 and combined with a massage therapy implement handle 68 to form a stand-alone, hand-held massage therapy implement 70. A forward end 68A of the handle 68 may be configured for attachment to the massage therapy implement 10 in the same manner as the forward end 8A of the reciprocally-driven member 8, such as by forming the forward end 68A with male threads. Many other attachment arrangements may also be used. The resultant hand-held massage therapy implement 70 may then be utilized (e.g., as a live sex toy) by activating the massage functions of the massage therapy implement 10 using the control buttons 46. When it is desired to re-use the massage therapy implement 10 as a stroking device, the user can easily detach the massage therapy implement from the handle 68 and re-attach it to the reciprocally-driven member 8 of the reciprocal drive unit 6.

One of the benefits of being able to detach the massage therapy implement 10 from the reciprocal drive unit 6 is that the massage therapy implement can be swapped out and replaced with additional massage therapy implements, some or all of which can be wirelessly controllable. This is shown in FIG. 16, wherein an alternative massage therapy implement 72 that is longer and narrower than the massage therapy implement 10 is shown to be attachable to the reciprocal drive unit 6. The massage therapy implement 72 may be configured for attachment to the forward end 8A of the reciprocally-driven member 8 in the same manner as the massage therapy implement 10. Thus, if the forward end 8A is formed with male threads, the massage therapy implement 72 may be formed with a female threaded socket 74 to facilitate removable attachment. Many other attachment arrangements may also be used. Like the massage therapy implement 10, the massage therapy implement 72 includes manual control buttons 76. Although not shown, the massage therapy implement 72 may have the same or similar internal components as the massage therapy implement 10, including but not limited to a motorized vibration component, a motorized rotating beads component, a battery power source, a control board, and a charge port. The massage therapy implement 72 may also include a wireless remote control interface (not shown) that can be controlled by the multi-function wireless remote control device 60 shown in FIG. 13.

By virtue of its female-threaded socket 74, the massage therapy implement 72 can be threadably attached to the male-threaded end 8A of the reciprocally-driven member 8 on the reciprocal drive unit 6. Like the massage therapy implement 10, the massage therapy implement 72 may also be unscrewed from the reciprocally-driven member 8 and screwed onto the massage therapy implement handle 68 in order to form a stand-alone massage therapy implement 78.

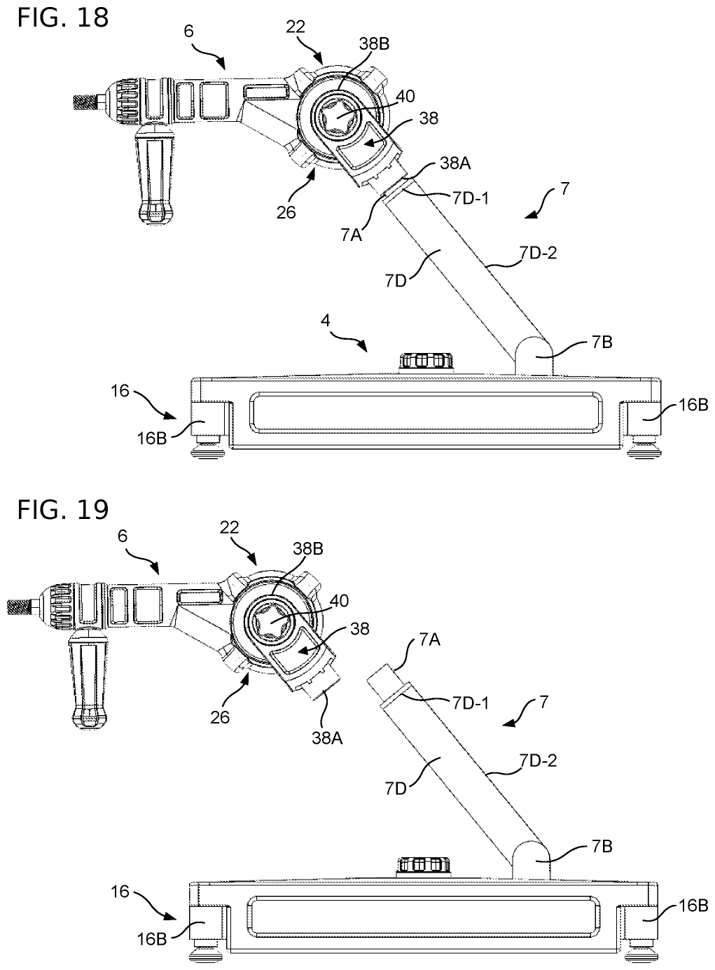

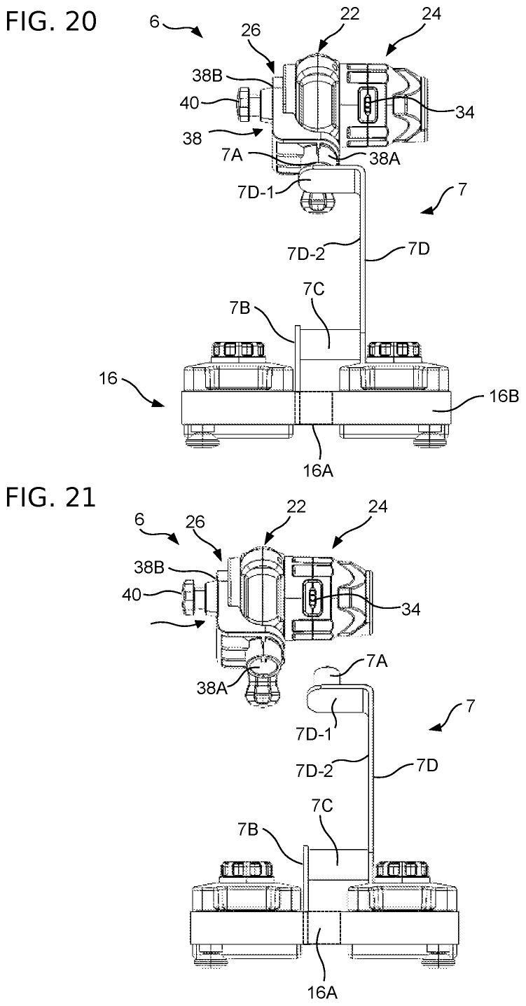

Turning now to FIGS. 18-21, an attachment arrangement is shown for mounting the reciprocal drive unit 6 to drive unit support frame 7. In particular, the tubular mounting socket 38A on the articulating mounting bracket 38 of the reciprocal drive unit 6 is configured to slidably receive and engage a tubular mounting post 7A formed on the forward free end of the drive unit support frame 7. This socket connection may be permanent or non-permanent, depending on design preferences. If a permanent socket connection is formed between the mounting socket 38A and the mounting post 7A, a non-detachable mounting arrangement will be provided. Likewise, if a non-permanent socket connection is formed between the mounting socket 38A and the mounting post 7A, a detachable mounting arrangement will be provided. FIGS. 18 and 20 depict the reciprocal drive unit 6 when it is attached to the drive unit support frame 7, while FIGS. 19 and 21 depict a detached state of the reciprocal drive unit. Many other attachment arrangements may also be used, including but not limited to, forming the articulating mounting bracket 38 and the drive unit support frame 7 as an integrated structure.

As can be seen in each of FIGS. 18-21, the lower end of the drive unit support frame 7 may be formed with a vertical connection stub 7B that attaches (permanently or non-permanently) to the base frame 16. As shown in FIGS. 20-21, the longitudinal frame section 16A of the base frame 16 may be used as an attachment point for the connection stub 7B. Additional elements that may be incorporated into the drive unit support frame 7 include a tubular offset element 7C that extends transversely from a free end of the connection stub 7B. One end of the offset element 7C is shown to be mounted to the connection stub 7B. The other end of the offset element 7C is mounted to an L-shaped arm element 7D of the drive unit support frame. The arm element 7D includes a short leg 7D-1 that extends transversely and carries the mounting post 7A. The arm element 7D further includes a longitudinal leg 7D-2 that extends upwardly and forwardly from the offset element 7C at a predetermined angle (e.g., 60 degrees). This angle is selected so as to position the reciprocal drive unit 6 (and whatever massage therapy implement is mounted thereon) at a favorable location for delivering massage therapy to a user situated in front of the massage therapy apparatus 2. In an embodiment, the elements 7A, 7B, 7C and 7D of the drive unit support frame 7 are part of a single rigid body that may formed by injection molding or the like. In other embodiments, one or more of the elements 7A, 7B, 7C and 7D could be discrete components that are joined in any suitable manner to other elements of the drive unit support frame 7. In such embodiments, the drive unit support frame 7 could be constructed so that one or more elements thereof can articulate. For example, the offset element 7C could be rotatably mounted between the connection stub 7B and the long leg 7D-2 of the arm element 7D, so as to form an articulation joint that allows the arm element to articulate relative to the connection stub.

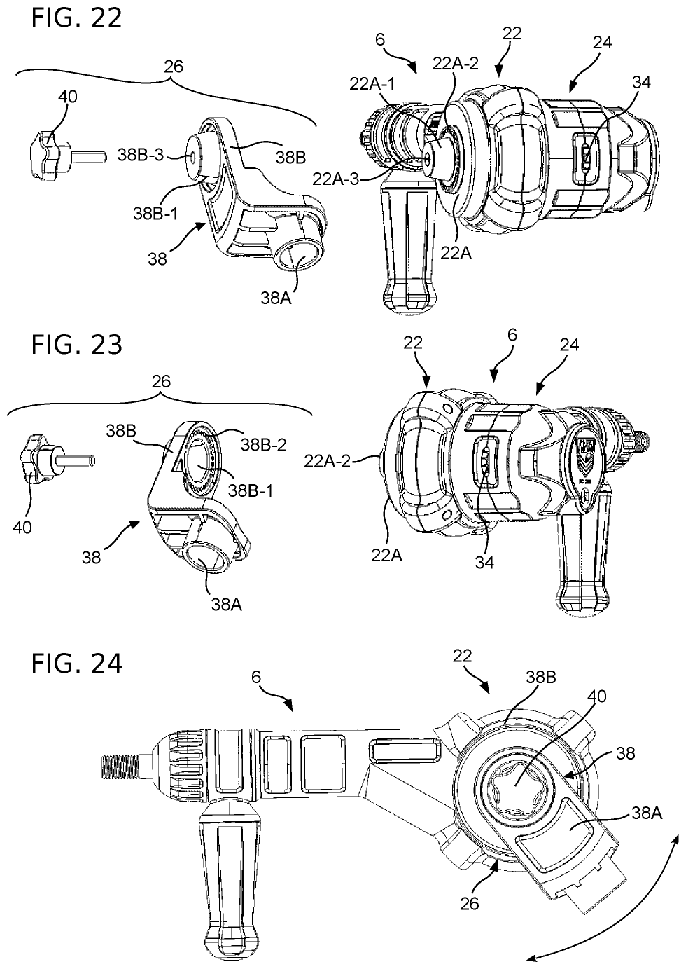

Turning now to FIGS. 22-24, the reciprocal drive unit 6 is shown in a state wherein the mounting connection assembly 26 thereof is detached from the main hub 22 and separated into its component parts, namely, the articulating member 38 and the thumb screw 40. For ease of illustration, the mounting connection assembly 26 is shown without the mounting frame assembly 8 appended to the mounting socket 38A. The rotary hub 38B of the articulating member 38 is shown to be mountable to a rotary locking plate 22A on the main hub 24. As can be seen in FIG. 22, the rotary locking plate 22A includes an alignment boss 22A-1 surrounded by a serrated ring 22A-2. As can be seen in FIG. 23, the rotary hub 38B of the articulating member 38 includes an alignment socket 38B-1 surrounded by a serrated ring 38B-2. When the articulating member 38 is mounted to the main hub 22, the alignment socket 38B-1 and the serrated ring 38B-2 of the rotary hub 38B respectively engage the alignment boss 22A-1 and the serrated ring 22A-2 of the locking plate 22A to form a Hirth coupling. As shown in FIG. 22, the thumb screw 40 extends through a central aperture 38B-3 in the structure that forms the alignment socket 38B-1, and threads into a threaded bore 22A-3 in the structure that forms the alignment boss 22A-1. Loosening the thumb screw 40 allows the articulating member 38 to be rotatably adjusted in the manner shown in FIG. 24, at multiple discreet rotational positions dictated by the serration rings 22A-2 and 38B-2. Re-tightening the thumb screw 40 locks the articulating member 38 in a fixed rotational position on the main hub 22.

Turning now to FIGS. 25-27, the reciprocal drive unit 6 is shown in a state wherein the articulating member 38 has been removed from the main hub 22 and replaced with an articulating reciprocal drive unit handle member 80 so that the reciprocal drive unit may be used as a stand-alone, handheld reciprocating massage therapy device 82. The combination of the articulating handle member 80 with the thumb screw 40 provides a rotatable handle assembly 26A that attaches to one side of the main hub 22. The articulating handle member 80 is similar to the articulating member 38 except that instead of a mounting socket 38A, it includes a handle 80A that is either formed on or attached to a rotary hub 80B. The handle 80A may then serve as a rear handle of the handheld reciprocating massage therapy device 82 that is disposed rearwardly from the previously-described front handle 30.

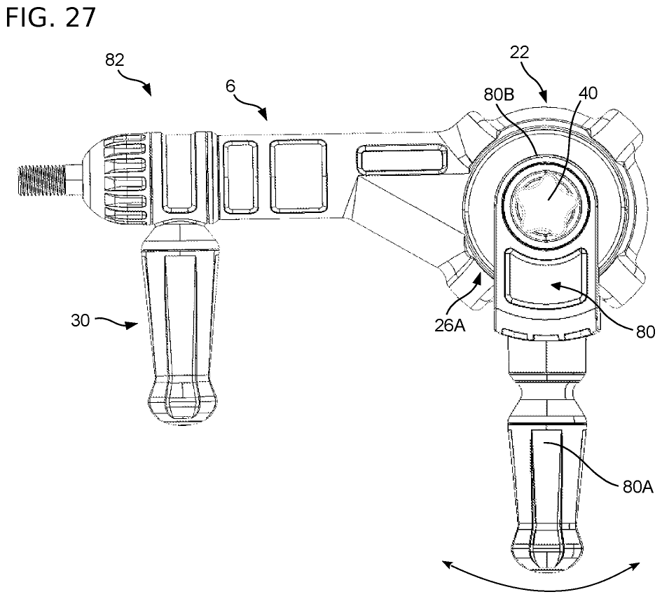

The rotary hub 80B may be configured so as to be identical to the rotary hub 38B of the articulating member 38 described above in connection with FIGS. 22-24. Thus, as can be seen in FIG. 26, the rotary hub 80B of the articulating handle member 80 may include an alignment socket 80B-1 surrounded by a serrated ring 80B-2. As can be seen in FIG. 25, when the articulating handle member 80 is mounted to the main hub 22, the alignment socket 80B-1 and the serrated ring 80B-2 of the rotary hub 80B respectively engage the alignment boss 22A-1 and the serrated ring 22A-2 of the locking plate 22A on the main hub 26 of the reciprocal drive unit 6 to form a Hirth coupling. The thumb screw 40 extends through a central aperture 80B-3 in the structure that forms the alignment socket 80B-1, and threads into the threaded bore 22A-3 in the structure that forms the alignment boss 22A-1. Loosening the thumb screw 40 allows the articulating handle member 80 to be rotatably adjusted in the manner shown in FIG. 27, at multiple discreet rotational positions dictated by the serration rings 22A-2 and 80B-2. Re-tightening the thumb screw 40 locks the articulating handle member 38 in a fixed rotational position on the main hub 22.

As can be seen in FIG. 27, the resultant handheld reciprocating massage therapy device 82 is equipped two handles (i.e., the front handle 30 and the rear handle 80A) for two-handed stroker operation. It will be seen that the handheld reciprocating massage therapy device 82 may be embodied with a configuration that resembles a handheld power tool, such as a two-handed, portable electric drill. Other configurations may also be used.

As an alternative to the illustrated embodiment shown in FIGS. 25-27, it would also be possible to modify the handle 80A so that it can be removably attached to the articulating member 38 of FIGS. 22-24, provided that the mounting socket 38A is detachable from the drive unit support frame 7 (which may or may not be the case). In such an embodiment, the handle 80A could be modified so that it includes a tubular mounting post (not shown) that fits into the mounting socket 38A of the articulating member 38, so that the handle can be attached and detached by a user of the massage therapy apparatus 2.

Turning now to FIG. 28, a reciprocating massage therapy kit 84 is shown. The kit 84 includes the massage therapy apparatus 2, but with the massage therapy implement 10 being detached from the reciprocal drive unit 6 and provided as a kit accessory. The kit 84 may further include the massage therapy implement 72 of FIGS. 16-17, which may be provided as another kit accessory, together with one or more of the wireless remote control 60 of FIG. 13, the massage therapy implement handle 68 of FIGS. 15 and 17, and the articulating handle member 80, each of which are also provided as a kit accessory. Additional massage therapy implements or alternative handles may also be provided as part of the kit 84.

Accordingly, a reciprocating massage therapy apparatus that may be provided on a standalone basis or in kit form as been disclosed. Although the massage therapy apparatus has been described and shown in the context of certain example embodiments, it should be apparent that variations and alternative embodiments could be implemented in accordance with the present disclosure.

Reference in the present disclosure to an “embodiment” means that a particular feature, structure or characteristic described in connection with the embodiment may be included in at least one embodiment of the disclosed apparatus. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples may be given throughout this description. These examples are merely descriptions of specific embodiments of the invention. The scope of the invention is not limited to the examples given.

As used in this application, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

It is understood, therefore, that the invention is not to be in any way limited except in accordance with the spirit of the appended claims and their equivalents.

What is claimed is:

1. A reciprocating massage therapy apparatus, comprising:
a base unit operable to rest on or mount to a surface that is external to the apparatus;
a reciprocal drive unit mounted to the base unit, the reciprocal drive unit comprising a reciprocally-driven member;
a massage therapy implement disposed on the reciprocally-driven member and arranged to stroke back and forth to apply cyclic therapeutic touching to a user's body part during use of the apparatus; and
the base comprising an adjustable ballast operable to apply a stabilizing force that enhances stability of the apparatus.

2. The apparatus of claim 1, wherein the ballast is attached to a base frame portion of the base unit.

3. The apparatus of claim 1, wherein the ballast is removably attached to the base frame.

4. The apparatus of claim 1, wherein the ballast is removably attached to the base frame in a manner that allows the ballast to be attached to the base frame and detached therefrom without the use of a tool device.

5. The apparatus of claim 1, wherein the ballast is removably attached to the base frame by thumb screws.

6. The apparatus of claim 1, wherein the ballast comprises a ballast container configured to hold a ballast material.

7. The apparatus of claim 1, wherein the ballast comprises a ballast container having a hollow interior configured to hold a ballast material, an opening for introducing the ballast material into the hollow interior, and a removable closure on the opening operable to close and seal the opening.

8. The apparatus of claim 6, wherein the ballast container holds a ballast material comprising a liquid, solid particulates, or a slurry.

9. The apparatus of claim 6, wherein the ballast container holds a ballast material comprising water, sand or a water/sand mixture.

10. The apparatus of claim 1, wherein the ballast comprises plural ballast containers configured to hold a ballast material.

11. The apparatus of claim 1, wherein the reciprocal drive unit comprises a wireless remote control interface operable to control the reciprocal drive unit to vary the back and forth stroke of the massage therapy implement based on control inputs from a wireless remote control device.

12. The apparatus of claim 11, wherein the massage therapy implement comprises one or more motorized components operable to deliver one or more associated massage therapy functions that are native to the massage therapy implement.

13. The apparatus of claim 12, wherein the massage therapy implement comprises a wireless remote control interface operable to control the one or more motorized components based on control inputs from a wireless remote control device in order to vary delivery of the one or more massage therapy functions of the massage therapy implement.

14. The apparatus of claim 13, further including a multi-function wireless remote control device provided as part of a massage therapy apparatus kit, the remote control device being operable to wirelessly communicate with the reciprocal drive unit wireless remote control interface and the massage therapy implement wireless remote control interface in order to selectively control (1) the reciprocally-driven member of the reciprocal drive unit to vary the back and forth stroke of the massage therapy implement, and (2) the one or more motorized components to vary delivery of the one or more massage therapy functions of the massage therapy implement.

15. The apparatus of claim 14, the massage therapy implement is detachable from the reciprocally-driven member and replaceable with additional wirelessly controllable massage therapy implements that can be selectively mounted to the reciprocally-driven member and controlled by the multi-function wireless remote control device, and wherein the apparatus comprises a set of one or more of the additional massage therapy implements provided as part of a massage therapy apparatus kit.

16. The apparatus of claim 1, wherein the massage therapy implement is detachable from the reciprocally-driven member and attachable to a massage therapy implement handle in order to use the massage therapy implement as a stand-alone, handheld massage therapy implement, and wherein the apparatus includes the massage therapy implement handle provided as part of a massage therapy apparatus kit.

17. The apparatus of claim 1, wherein the reciprocal drive unit is mounted to the base by a drive unit support frame.

18. The apparatus of claim 17, wherein the reciprocal drive unit comprises a mounting connection assembly that detachably connects to the drive unit support frame, and wherein the apparatus further comprises a reciprocal drive unit handle provided as part of a massage therapy apparatus kit, the reciprocal drive unit handle being attachable to the reciprocal drive unit when the mounting connection assembly is detached from the drive unit support frame in order to use the reciprocal drive unit as a stand-alone, handheld reciprocating massage therapy device.

19. The apparatus of claim 1, wherein the base comprises non-suction gripping foot members positioned to grip the external surface.

20. A reciprocating massage therapy apparatus, comprising:
a base unit operable to rest on or mount to a surface that is external to the apparatus;
a reciprocal drive unit mounted to the base unit, the reciprocal drive unit comprising a reciprocally-driven member;
a massage therapy implement disposed on the reciprocally-driven member for stroking back and forth to apply cyclic therapeutic touching to a user's body part during use of the apparatus;
the massage therapy implement comprising one or more motorized components operable to deliver one or more associated massage therapy functions that are native to the massage therapy implement;
the reciprocal drive unit comprising a wireless remote control interface operable to control the reciprocally-driven member to vary the back and forth stroke of the first or second massage therapy implement based on control inputs from a wireless remote control device;
the massage therapy implement comprising a wireless remote control interface operable to control the one or more motorized components based on control inputs from the wireless remote control device in order to vary delivery of the one or more massage therapy functions of the massage therapy implement; and
a multi-function wireless remote control device operable to wirelessly communicate with the reciprocal drive unit wireless remote control interface and the massage therapy implement wireless remote control interface of the first massage therapy implement and the second massage therapy implement in order to selectively control (1) the reciprocally-driven member of the reciprocal drive unit to vary the back and forth stroke of the massage therapy implement, and (2) the one or more motorized components to vary delivery of the one or more massage therapy functions of the massage therapy implement.

21. A reciprocating massage therapy kit, comprising:
a massage therapy apparatus, comprising:
a base unit operable to rest on or mount to a surface that is external to the apparatus;
a reciprocal drive unit detachably mounted to the base unit, the reciprocal drive unit comprising a reciprocally-driven member that strokes back and forth; and
the reciprocal drive unit comprising a wireless remote control interface operable to control the reciprocally-driven member to vary the back and forth stroke thereof based on control inputs from a wireless remote control device;
a first massage therapy implement detachably mountable on the reciprocally-driven member for stroking back and forth to apply cyclic therapeutic touching to a user's body part during use of the massage therapy apparatus;
a second massage therapy implement detachably mountable on the reciprocally-driven member for stroking back and forth to apply cyclic therapeutic touching to a user's body part during use of the massage therapy apparatus;
the first massage therapy implement and the second massage therapy implement each comprising one or more motorized components operable to deliver one or more associated massage therapy functions;
the first massage therapy implement and the second massage therapy implement each comprising wireless remote control interface operable to control the one or more motorized components of that massage therapy implement based on control inputs from a wireless remote control device in order to vary delivery of the one or more massage therapy functions;
a multi-function wireless remote control device operable to wirelessly communicate with the reciprocal drive unit wireless remote control interface and the massage therapy implement wireless remote control interface of the first massage therapy implement and the second massage therapy implement in order to selectively control (1) the reciprocally-driven member of the reciprocal drive unit to vary the back and forth stroke thereof, and (2) the one or more motorized components of the first massage therapy implement and the second massage therapy implement to vary delivery of the one or more massage therapy functions of that massage therapy implement;
a massage therapy implement handle that is selectively attachable to the first massage therapy implement and the second massage therapy implement so that they can function as stand-alone, handheld massage therapy implements; and
a reciprocal drive unit handle that is attachable to the reciprocal drive unit when it is detached from the base in order to form a stand-alone, handheld reciprocating massage therapy device.
